(19) United States
(12) Patent Application Publication
(10) Pub. No.: US 2010/0259371 A1
(43) Pub. Date: Oct. 14, 2010

(54) Bird-View Parking Aid Apparatus with Ultrasonic Obstacle Marking and Method of Maneuvering the same

(76) Inventors: Jui-Hung WU, Kaohsiung County (TW); Li-Wei Lin, Kaohsiung County (TW); Chia-Yuan Chang, Kaohsiung County (TW)

Correspondence Address: HDLS IPR Services, PO Box 220746, Chantilly, VA, 20153, US

(21) Appl. No.: 12/422,240

(22) Filed: Apr. 10, 2009

(51) Int. Cl. B60Q 1/00; G06K 9/00

(52) U.S. Cl. 340/435; 382/106

(57) ABSTRACT

A bird-view parking aid apparatus with ultrasonic obstacle marking includes an image acquisition unit, a ultrasonic sensor unit, an alarm unit, a display unit and a processing unit, wherein the processing unit is connected with the image acquisition unit, the ultrasonic sensor unit, and the display unit. Upon receiving a reversing gear signal, the processing unit acquires the rearview image of the vehicle and the information of the obstacle distance via image acquisition unit and the ultrasonic sensor unit, afterwards the actual position of the obstacle is calculated as per the built-in ultrasonic positioning formula, and at the same time, the existing position of the obstacle is marked on the rearview image, and transmitted to the display unit, and also the method of maneuvering the apparatus is disclosed.

### BACKGROUND OF THE INVENTION

1. Field of the Invention

The present invention relates to a bird-view parking aid apparatus with ultrasonic obstacle marking, and in particular, to an apparatus which can serve to provide information of actual position of the obstacle by ultrasonic positioning so as to warn the driver against the potential danger, and method of maneuvering the same.

2. Description of the Prior Art

There are two kinds of parking aid systems most commonly used in the present day. One is ultrasonic type and the other is imaging type. For the ultrasonic type, ultrasonic sensors are installed on the rear bumper of a vehicle so as to detect obstacles and output audio alarms for alerting the driver to the danger of possible collision. For the imaging type, a camera is used to directly capture the rearview image of the vehicle and then show it onto the screen laid on the instrument panel for parking reference.

However, both means aforementioned can never work satisfactorily. The conventional ultrasonic-based parking aid system can only provide the radial distance of an obstacle from the detecting sensor, but can not identify its orientation exactly. That is, the driver can not know the actual distance between an obstacle and the bumper and which direction the obstacle is at as well. On the contrary, the imaging-based parking aid system can only provide the rearview image to let the driver see more easily where the obstacle is, but is hard to visually estimate the distance from an obstacle correctly. The practicability of both means is insufficient. For these shortcoming noticeable on the prior art, an improvement is seriously required.

It is what the reason the inventor of the present invention has put every effort for years by continuous research and experimentation in a bid to find out the remedy to palliate the inherent shortcomings of the conventional techniques described above, and at last has succeeded in realizing the present invention.

### SUMMARY OF THE INVENTION

The essential object of the present invention is to provide a bird-view parking aid apparatus with ultrasonic obstacle marking which can rectify the flaws of conventional parking aid apparatuses, for example, unable to know about the real position of the obstacle when employing the ultrasonic way and difficult to visually estimate the distance of an obstacle when employing the imaging way, and also to provide method of maneuvering the same.

To achieve the above object, the apparatus comprises an image acquisition unit, an ultrasonic sensor unit, an alarm unit, a display unit, and a processing unit, wherein the processing unit is in connection with the image acquisition unit, the ultrasonic sensor unit, the alarm unit, and the display unit.

Upon receiving a reversing (R) gear signal, the processing unit obtains the rearview image of the vehicle and the information of the obstacle distance via image acquisition unit and the ultrasonic sensor unit. Subsequently, the actual position of the obstacle is figured out according to a built-in ultrasonic positioning formula, and at the same time the existing location of the obstacle is marked on the rearview image, and outputted to the display unit.

In case the vehicle body is too close to the obstacle, an alarm signal is delivered to the alarm unit from the processing unit, and the original rearview image is automatically changed over to a vertical view (bird-view image) according to a built-in image coordinate conversion formula so as to provide a better space visual effect, thereby precisely determining the distance between the vehicle and the obstacle.

Other objects and advantages of the invention will be apparent to persons acquainted with apparatus of this general type upon reading the following specification and inspection of the accompanying drawings.

### BRIEF DESCRIPTION OF THE DRAWINGS

FIG. 1 is a perspective view of the apparatus according to the present invention.

FIG. 2 is a flow chart of the operation of the parking aid apparatus according to the present invention.

FIG. 3 is a rearview image taken by the parking aid apparatus of the present invention.

FIG. 4 is a bird-view image taken by the parking aid apparatus of the present invention.

### DETAILED DESCRIPTION OF THE PREFERRED EMBODIMENT

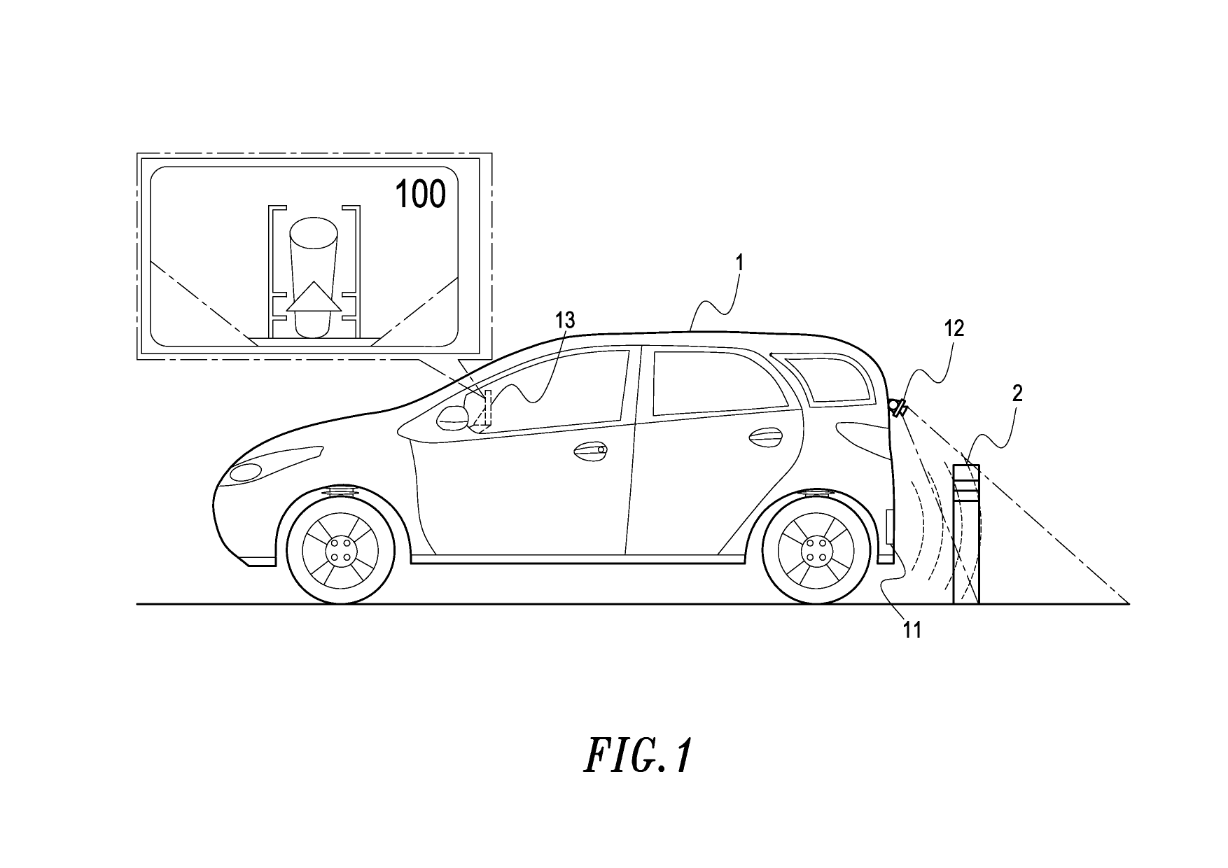

Referring to FIG. 1, the bird-view parking aid apparatus is installed on a car body 1 to detect the distance of the obstacle 2 behind the car body 1 by ultrasonic sensor 11, and capture the rearview image of the vehicle body 1 by a camera 12, thereby displaying the information of the obstacle 2 existing at the rear of the vehicle body 1 including distance and image on the screen 13.

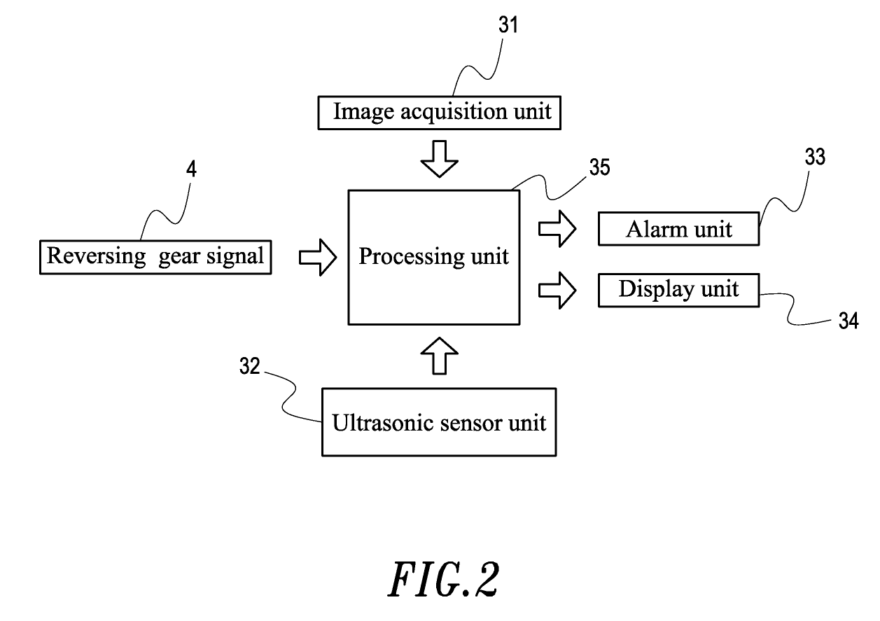

Referring to FIG. 2, the parking aid apparatus comprises an image acquisition unit 31, an ultrasonic sensor unit 32 an alarm unit 33, a display unit 34, and a processing unit 35.

The image acquisition unit 31 installed on the outer vehicle body 1 is connected to the processing unit 35 to capture the image of the vehicle surroundings and transmit the image to the processing unit 35.

The ultrasonic sensor unit 32 installed on the vehicle body 1 is connected to the processing unit 35 to perform ultrasonic distance detection of the outside condition around the vehicle, and transmit the result to the processing unit 35.

The alarm unit 33 connected to and controlled by the processing unit 35 is capable of warning the driver when the vehicle is too close to the obstacle 2.

The display unit 34 connected to the processing unit 35 is for displaying the image. The display unit 34 may be of a touch screen allowing the user for adjustment and setting.

The processing unit 35 is in connection with the image acquisition unit 31, the ultrasonic sensor unit 32, the alarm unit 33 and the display unit 34. Upon receiving a reversing gear signal 4. The processing unit 35 acquires the information of a vehicle rearview image and the distance of obstacle 2 via image acquisition unit 31 and the ultrasonic sensor unit 32. The actual position of the obstacle 2 is figured out by a built-in ultrasonic positioning formula and marked on the original image. Then the original rearview image, the distance between the vehicle body 1 and the obstacle 2 and the alarm mark 5 are combined to show on the display unit 34, wherein the alarm mark 5 is for positioning the actual location of the obstacle 2.

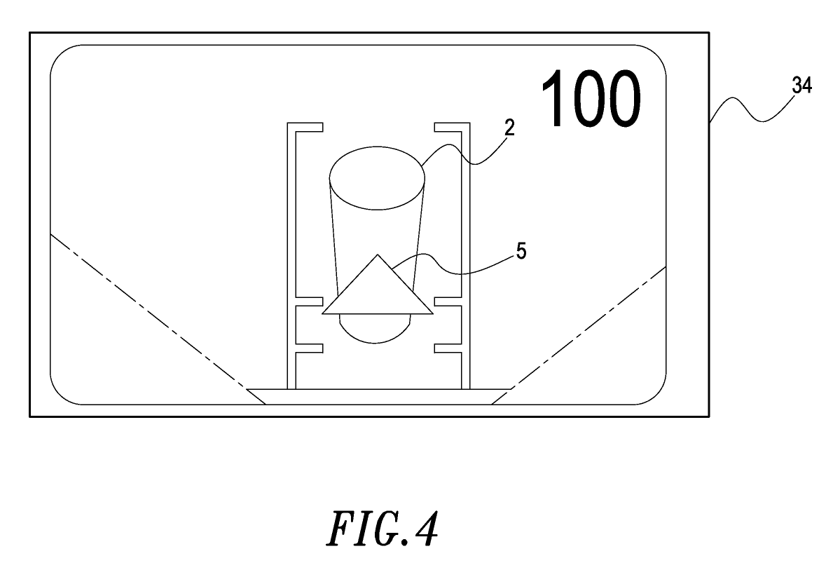

In case the vehicle body 1 is too close to the obstacle 2, the processing unit 35 outputs an alarm signal to the alarm unit 33, and uses a built-in image coordinate conversion formula to automatically convert the originally taken rearview image to a vertical view (bird-view) so as to provide a better visual effect for estimate the distance when the vehicle is approaching the obstacle 2 (see FIG. 4).

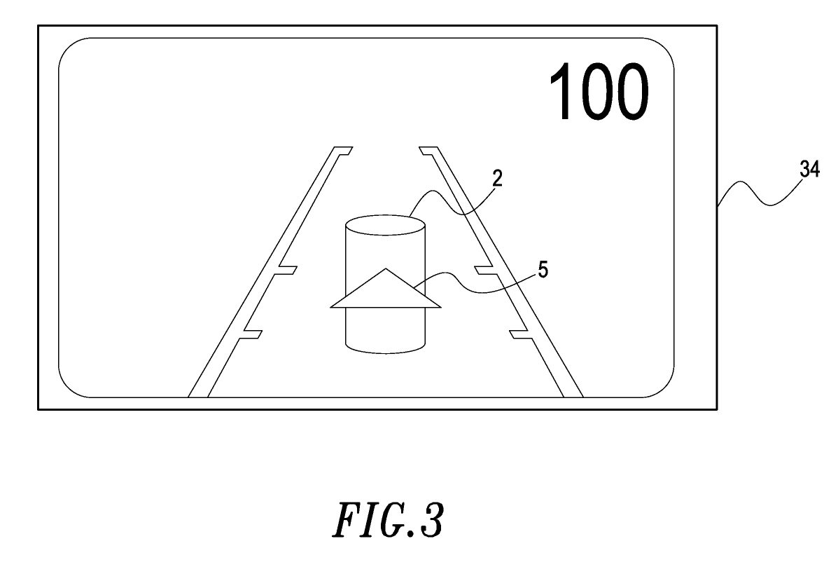

FIG. 3 and FIG. 4, respectively, illustrate the original rearview and the bird-view images with the alarm mark 5 of obstacle location processed by the processing unit 35. The switching between the original rearview and the bird-view images is automatic and mainly based on the distance of obstacle 2 detected by the ultrasonic sensor unit 32. Moreover, the information about the obstacle 2 including the real distance (e.g. 100 mm) from the bumper and alarm mark 5 of the location are superimposed onto the images and then shown on the display unit 34 thereby achieving the best parking aid effect.

As for the conversion formula for the bird-view is expressed as follows:

$$s [ \begin{matrix}{u}_{B} \\ {v}_{B} \\ 1\end{matrix} ] = A [ R \vert T ] [ \begin{matrix}{X}_{w} \\ {Y}_{w} \\ {Z}_{w} \\ 1\end{matrix} ]$$

Where [u_{B}, v_{B}] denotes a point of the bird-view image coordinate system and [X_{W}, Y_{W}, Z_{W}] denotes a point of the world coordinate system, s is an arbitrary scale factor, R and T are, respectively, the 3×3 rotation and 1×3 translation matrixes which relate the world coordinate system to the bird-view image coordinate system, and A is the camera intrinsic matrix given by

$$A = [ \begin{matrix}δ & 0 & {u}_{0} \\ 0 & ɛ & {v}_{0} \\ 0 & 0 & 1\end{matrix} ]$$

with [uₒ, vₒ] the coordinates of principal point, δ and ε the scale factors in bird-view image μ and ν axes.

In brief, it emerges from the description of the above embodiment that the invention has several noteworthy advantages as compared with the conventional techniques, in particular:

1. The present invention converts the original rearview image into an up to down bird-view image that can provide a better visual effect for judging the distance when the vehicle approaches the obstacle.

2. The present invention employs the technique of ultrasonic positioning that can mark the location of the obstacle on the image captured to identify the obstacle at once.

3. By utilizing the ultrasonic distance detection, the original rearview image is automatically changed over to a bird-view image when the vehicle is approaching the obstacle thereby achieving the best parking aid effect.

It is apparent to a person skilled in the art that the basic idea of the invention can be implemented in many different ways. The invention and its embodiment are thus not restricted to the examples described above but may vary with the scope of the claims.

The present invention is a high level technical creation and by no means simply utilizes conventional technology or knowledge known prior to the application for patent or can easily made by persons skilled in the arts prior to the application for patent, the invention has neither been published or put to public use, nor displayed in an exhibition, therefore the present invention is entitled for a patent.

What is claimed is:

1. A bird-view parking aid apparatus with ultrasonic obstacle marking, comprising:
an image acquisition unit connected to a processing unit for acquiring the image of a vehicle surroundings, and transmitting the said image to the said processing unit;
an ultrasonic sensor unit connected to the said processing unit for performing distance detection of obstacles outside the said vehicle and transmitting information of the said detected distance to the said processing unit;
a display unit connected to the said processing unit for displaying an image; wherein
the said processing unit is in connection with the said image acquisition unit, the said ultrasonic sensor unit, the said display unit and an alarm unit, and acquires the image of the said vehicle surroundings with the said image acquisition unit, and the information of the obstacle distance with the said ultrasonic sensor unit to perform the bird-view transformation and the obstacle positioning thereby showing an image with the alarm mark of the obstacle location on the said display unit for achieving the best parking aid effect.

2. The parking aid apparatus of claim 1, wherein the said display unit is a touch screen which can be used to carry out the adjustment and setting directly.

3. The parking aid apparatus of claim 1, wherein the said alarm unit is controlled by the said processing unit to warn the driver when the vehicle approaches too close to the said obstacle.

4. The method of maneuvering a bird-view parking aid apparatus, comprising the steps of:
upon receiving a reversing gear signal, a processing unit receiving information of a rearview image of the vehicle from an image acquisition unit, and an obstacle distance from a ultrasonic sensor unit;
figuring out the actual position of the obstacle with a built-in ultrasonic positioning formula;
combining information of the original rearview image of the vehicle, the distance between the vehicle bumper and the obstacle, and an alarm mark of obstacle location to output to the said display unit; wherein the said alarm mark is for pointing out the actual location of the obstacle in the image;
outputting an alarm signal to the said alarm unit from the said processing unit in case the vehicle is too close to the said obstacle; and
using a built-in image coordinate conversion formula to automatically convert the said original rearview picture to a vertical bird-view image so as to provide a better visual effect for precisely judging the distance between the vehicle bumper and the obstacle while approaching.

5. The method of claim 4, wherein the said processing unit is able to locate the actual existing position of the said obstacle according to the distance information obtained from the said ultrasonic sensor unit.

6. The method of claim 4, wherein the display between the rearview and bird-view images with the alarm mark of obstacle location treated by the said processing unit can be automatically switched in accordance with the obstacle distance detected by the said ultrasonic sensor unit.
